(19) United States
(12) Patent Application Publication
(10) Pub. No.: US 2026/0109048 A1
(43) Pub. Date: Apr. 23, 2026

(54) ERGONOMIC CONTROL DEVICE

(71) Applicant: COMMISSARIAT A L'ENERGIE ATOMIQUE ET AUX ENERGIES ALTERNATIVES, Paris (FR)

(72) Inventors: Henry-Noel DE-GRANDE, PONT SAINT ESPRIT (FR); Pascal CONTY, SAINT ALEXANDRE (FR)

(21) Appl. No.: 19/120,897

(22) PCT Filed: Oct. 25, 2023
(86) PCT No.: PCT/EP2023/079807

§ 371 Date: Apr. 14, 2025

(30) Foreign Application Priority Data
Oct. 28, 2022 (FR) FR2211278

(51) Int. Cl. B25J 13/06; B25J 9/16

(52) U.S. Cl. CPC B25J 13/06; B25J 9/1689

(57) ABSTRACT

The invention relates to an ergonomic control device, in particular for a wall telemanipulator, including a control handle, a control box having one or more control members for controlling one or more motors, in particular of the wall telemanipulator, the control box being mounted on the control handle and being movable relative thereto with at least two degrees of freedom, or even three degrees of freedom.

### TECHNICAL FIELD

The present invention relates to controlling telemanipulators, notably wall telemanipulators, in particular using a control handle. A telemanipulator is set in motion by means of electric motors controlled from a control device comprising a control unit placed on a control handle.

### PRIOR ART

The electric signal that controls the one or more motors passes through an electric cable between the control unit on the handle of the telemanipulator and a power casing for the actuators of the motors. This electric cable is located in the operating field of the user, which can hinder the handling of the telemanipulator and cause jamming, with a risk of damage due to the fact that the electric cable needs to remain spatially free in order to be able to follow the actions demanded by the user. There is a risk of the cable being blocked, damaged or pulled.

In order to guarantee safety and to avoid damage to the protective sheath of the electric cable, it is known practice for it to be protected by a plastic casing, for example, a spiral sheath,

To date, the user must pay close attention to this cable, ensuring that it is not inadvertently wound around the handle. Thus, the user must adapt to the handle to the detriment of their dexterity. Indeed, handling of the handle can be blocked by the tension of the cable.

Furthermore, during specific maneuvers, the user may not have a sufficient view of the control unit. Notably, some of the markers present on this unit may not be visible. Often, the user may have to assume awkward positions, for example, with their head upside-down or squatting, in order to gain access to the control unit.

Finally, it is not possible to quickly interchange the control unit between several wall telemanipulators, for example, if one of them broke down. Indeed, wired control units permanently remain on the handles. They are not separable. Furthermore, uncontrolled use of the equipment may occur.

Therefore, a requirement exists to overcome all or some of these disadvantages.

### SUMMARY OF THE INVENTION

Thus, the aim of the invention, according to one of the aspects thereof, is an ergonomic control device, notably for a wall telemanipulator, comprising:
a control handle;
a control unit comprising one or more control components for controlling one or more motors, notably of the wall telemanipulator;
   the control unit being mounted on the control handle, being movable relative thereto with at least two degrees of freedom, or even three degrees of freedom,

By virtue of the invention, the control unit is movable relative to the control handle, being able to be oriented as desired by the user, thereby improving its visibility by the user and facilitating the handling thereof.

### DISCLOSURE OF THE INVENTION

The control unit can be devoid of a wired link.

The control unit notably can be devoid of a wired link with the one or more motors to be controlled. The control unit can be connected to the one or more motors to be controlled by a wireless link. This advantageously avoids the presence of a wire around the control unit, which could hinder the movement thereof relative to the control handle. The movement of the control unit is thus facilitated. There is no electric wire or cable in the operative field of the user, thereby improving the safety of the user and facilitating their handling operations. Indeed, any risk of the user contacting a bare live electric cable is thus avoided.

The absence of an electric cable also avoids any risk of unwanted winding of the cable around the control handle, and/or of the cable pulling. Thus, any risk of an electric failure resulting from the presence of an electric cable, such as, for example, pinching the cable, untimely disconnection or the like, is eliminated.

Advantageously, the control unit also can be separated from the control handle, and can be used with another control handle. This interchangeability increases responsiveness in the event of the failure of a control unit.

The device can be configured for the control unit to be movable between two positions symmetrical to each other relative to the control handle.

Thus, the device is ambidextrous for the user. It is also practical to use, whether the user handles it with the right hand or the left hand, and whether they are right-handed or left-handed. This can allow the control precision to be improved, and can also allow a saving to be made on the purchase price.

The user can handle the unit so that it is always within sight and is oriented correctly, irrespective of their position, according to the handling thereof. The ergonomics for controlling the control device are improved. The ease of use is also improved, as is the security and the safety of users. The risk of human error due to misreading is minimized.

The control unit can be oriented relative to the control handle in all directions.

The control unit can be mounted on a rotary ring rotatably mounted on the control handle.

The rotary ring can extend over less than 360°, for example, less than 320°, more preferably less than 240°, or even less than 200°, for example, over approximately 180°. Reference can be made to a rotary half-ring.

Thus, the rotary ring can rotate around the control handle, notably over more than 120°, or even more than 180°, more preferably more than 240°, or even more than 300°, more preferably more than 320°, notably over approximately 360°. The control unit thus can be rotated completely around the control handle.

The user can thus position the control unit as desired, so that it is always in their sight.

The device can comprise a fixed ring fixedly mounted on the control handle. The rotary ring can be mounted on the fixed ring of the control handle. The rotary ring can easily clip on and unclip from the fixed ring.

The fixed ring can be perforated and the rotary ring can be mounted with a return pin in the perforation of the fixed ring. The device can comprise a spring to allow the return to occur. The return spring can allow the rotary ring to be easily locked and unlocked. Thus, the control unit can rotate completely around its shaft that connects it to the rotary ring.

As a variant or additionally, the control unit can be mounted with a ball joint on the control handle, or even by means of a magnetized connection.

The control unit can be detached from the control handle. The control unit is particularly detachably mounted on the control handle. This allows the user to remove the control unit from the device at the end of use, notably at the end of a shift, and thus secure the one or more telemanipulators by making them unusable. The telemanipulator is not likely to be handled accidentally or uncontrollably.

Furthermore, this can allow easy and quick interchangeability of the control units, for example, in the event that a control unit fails, notably in the event that there are several wall telemanipulators with several control units. A control unit can be used to control any motors.

The control unit can comprise a plurality of control components, notably two control components per motor to be controlled, notably six control components.

The control unit can be configured to control one or more motors, for example, one, two or three motors. Each motor can be configured to control the movement of the wall telemanipulator according to a degree of freedom. Notably, there can be one motor per axis of movement of the wall telemanipulator.

The control handle can comprise a lever for closing the clamp of the slave arm.

The device can comprise an indicator, notably a light indicator, for the selected control component. This indicator makes the control unit easy to read by the user. It notably allows the axis of movement of the selected wall telemanipulator to be known. It can involve including one or more batteries in the control unit.

At least one control component, or even all the control components, can be tactile. This allows a modern and ergonomic control unit to be provided, and makes the control unit easy to read by the user. It notably allows the axis of movement of the selected wall telemanipulator to be known. It can involve including one or more batteries in the control unit.

As a variant, they may not be tactile.

At least one control component, or even all the control components, can be tactile with voice or sound feedback. Such a configuration can allow users to know the axis of movement of the selected wall telemanipulator. It can involve including one or more batteries in the control unit.

In one embodiment, the control unit can be devoid of batteries for its power supply.

In one embodiment, the control unit can be equipped with a magnetized connection over its entire surface, allowing it to be fixed on a remote metal support.

A further aim of the invention, independently or in combination with the above, is a wall telemanipulator comprising a control device as described above.

The wall telemanipulator can comprise a relay unit configured to receive control signals from the control unit. The relay unit can be connected to the one or more motors of the telemanipulator by a wired link.

The wall telemanipulator can be used for any application sector, such as, for example, the nuclear, pharmaceutical, chemical, or space sector, with this list being by no means limiting.

### BRIEF DESCRIPTION OF THE DRAWINGS

The invention will be better understood upon reading the following detailed description of non-limiting embodiments thereof, and with reference to the appended drawings, in which:

FIG. 1 is a perspective view of a control device according to the invention;

FIG. 2 illustrates the control device of FIG. 1 in various positions;

FIG. 3 is an exploded detailed view of the control device of FIG. 1;

FIG. 4 illustrates the operation of the control of the X-axis of a wall telemanipulator according to the invention.

### DETAILED DESCRIPTION

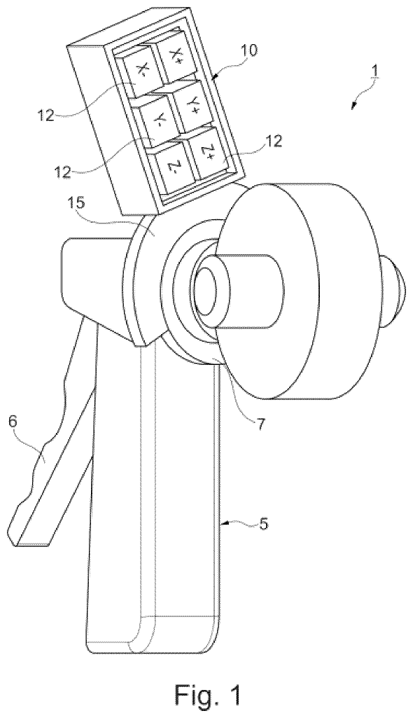

FIG. 1 illustrates an ergonomic control device 1 for a wall telemanipulator. The ergonomic control device 1 comprises a control handle 5 and a control unit 10 comprising a plurality of control components 12 for controlling one or more motors of the wall telemanipulator.

The control handle comprises a lever 6, which allows the closure of the clamp on the slave arm side to be mechanically controlled.

The control unit is configured to control three motors in the example described. Each motor is configured to control the movement of the wall telemanipulator according to a degree of freedom. Notably, there is one motor per axis of movement of the wall telemanipulator. The axes are indicated by X, Y and Z herein.

The control unit thus comprises six control components 12, with two control components per motor to be controlled, with the control components thus being designated as X+, X−, Y+, Y−, Z+and Z−.

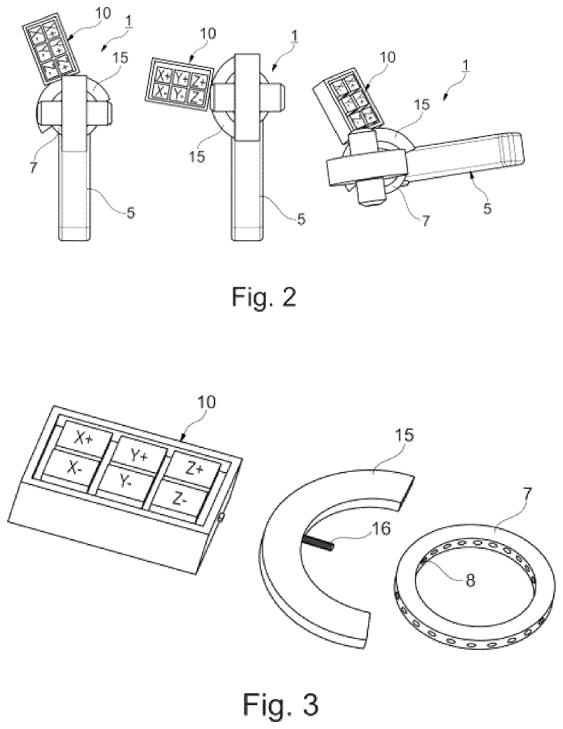

The control unit 10 is mounted on the control handle 5, being movable relative thereto with several degrees of freedom, as described hereafter. Thus, the control unit is movable relative to the control handle, being able to be oriented as desired by the user, as shown in FIG. 2, thereby improving its visibility by the user and facilitating the handling thereof.

Furthermore, the wall telemanipulator comprises a relay unit configured to receive the control signals from the control unit. The relay unit can be connected to the motors of the telemanipulator by a wired connection.

The control unit 10 is devoid of a wired link, in particular with the motors to be controlled, The control unit in this case is connected to the one or more motors to be controlled by a wireless link. This advantageously avoids the presence of a wire around the control unit, which could hinder the movement thereof relative to the control handle.

The control unit is also devoid of batteries for its power supply,

The device is configured so that the control unit is movable between two positions symmetrical to each other relative to the control handle. It can be seen that the device is ambidextrous for the user. The user can handle the unit so that it is always within sight and is oriented correctly, irrespective of their position, according to the handling thereof.

The control unit 10 can be oriented relative to the control handle in all directions. To this end, the control unit 10 is mounted on a rotary ring 15 rotatably mounted on the control handle 5. The rotary ring 15 extends, in this example, over approximately 180°. Reference can be made to a rotary half-ring. Thus, the rotary half-ring 15 can rotate around the control handle over approximately 360°. The control unit thus can be rotated all around the control handle.

Furthermore, the device comprises a fixed ring 7 fixedly mounted on the control handle 5. The rotary ring 15 is mounted on the fixed ring 7 of the control handle 5. The rotary ring 15 can easily clip on and unclip from the fixed ring 7.

The fixed ring 7 is perforated and the rotary ring 15 is mounted with a return pin 16 in the perforation 8 of the fixed ring, as shown in FIG. 3. The device comprises a spring to allow the return to occur. The return spring can allow the rotary ring 15 to be easily locked and unlocked.

Moreover, the control unit 10 is detachable from the control handle 5. The control unit 10 is actually detachably mounted on the control handle 5.

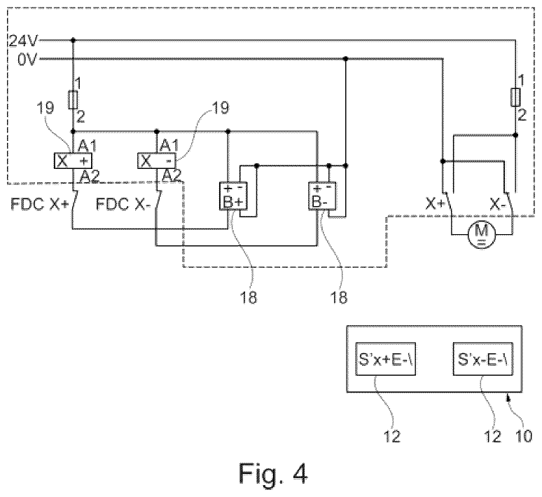

The control of the X-axis of a GETINGE LA CALHENE MT 200 model wall manipulator will now be described with reference to FIG. 4. The operating principle is as follows.

Pressing the “S'X+” button on the control handle 5 sends a signal to the wireless control relay 18 “B+”, which, upon closing its internal dry contact, allows the relay 19 “X+” to be powered.

The contact of the relay 19 “X+” allows the motor M to be powered. It rotates in one direction.

Conversely, when the contact “S'X+” is activated, the motor M rotates in the other direction.

1. An ergonomic control device, notably for a wall telemanipulator, comprising:
a control handle;
a control unit comprising one or more control components for controlling one or more motors, notably for a wall telemanipulator;
the control unit being mounted on the control handle, being movable relative thereto with at least two degrees of freedom, or even three degrees of freedom, the control unit being mounted on a rotary ring rotatably mounted on the control handle (5) and/or the control unit being mounted with a ball joint on the control handle.

2. The control device as claimed in claim 1, the control unit being devoid of a wired link.

3. The control device as claimed in claim 1, being configured so that the control unit is movable between two positions symmetrical to each other relative to the control handle.

4. The control device as claimed in claim 1, comprising a fixed ring fixedly mounted on the control handle.

5. The control device as claimed in claim 4, the rotary ring being mounted on the fixed ring of the control handle.

6. The control device as claimed in claim 5, the fixed ring being perforated and the rotary ring being mounted with a return pin in the perforation of the fixed ring.

7. The control device as claimed in claim 1, the control unit being detachable from the control handle.

8. The control device as claimed in claim 1, comprising an indicator, for the selected control component.

9. The control device as claimed in claim 1, at least one control component, or even all the control components, being tactile.

10. The control device as claimed in claim 1, at least one control component, or even all the control components, being tactile with voice or sound feedback.

11. The control device as claimed in claim 1, the control unit being devoid of batteries for its power supply.

12. The control device as claimed in claim 1, the control unit being equipped with a magnetized connection over its entire surface, allowing it to be fixed on a remote metal support.

13. A wall telemanipulator comprising a control device as claimed in claim 1.

14. The wall telemanipulator as claimed in claim 13, comprising a relay unit configured to receive control signals from the control unit.
